(19) United States
(12) Patent Application Publication
(10) Pub. No.: US 2012/0304097 A1
(43) Pub. Date: Nov. 29, 2012

(54) System And Method For Mapping Of Biological Sequences

(76) Inventors: Praguna Singh Sambyal, East Delhi (IN); Anoop Sankar, Gurgaon (IN)

(21) Appl. No.: 13/443,918

(22) Filed: Apr. 11, 2012

(30) Foreign Application Priority Data
Apr. 13, 2011 (IN) 1070/DEL/2011

(51) Int. Cl. G06F 3/048

(52) U.S. Cl. 715/771

(57) ABSTRACT

A system and a method for displaying a mapping between one or more nucleic acid sequences and a biological sequence are disclosed. In an embodiment, a user provides a set of input parameters. Based on the input parameters, the system carries out mapping between the nucleic acid sequences and the biological sequence and generates a visual map to depict the mapping. The visual map is then displayed to the user.

### CROSS REFERENCE TO RELATED APPLICATIONS

The present application claims priority from the provisional application filed on Apr. 13, 2011, application no: 1070/DEL/2011 titled “System and method for sequence mapping”.

### FIELD

The disclosure relates to the field of bioinformatics. In particular, the disclosure relates to systems and methods for displaying a mapping between multiple biological sequences.

### BACKGROUND

Recent advancements in biological sequencing technology have lead to a number of emerging technologies for providing faster sequencing means/methods, thereby reducing the associated cost. The cost of biological sequencing is calculated in terms of cost per base pair. However, the major challenge lies in the fact that after sequencing, the biological sequence has to be annotated accurately to depict meaningful information. A typical annotation process comprises identifying the locations of genes, their upstream and downstream information or flanking region sequences, and other genetic control elements with respect to the corresponding biological sequence.

Large repositories of sequences and corresponding annotated information are available through publicly available databases such as National Center for Biotechnology Information (NCBI), European Bioinformatics Institute (EMBL), etc. Further, the annotated information is also available through paid commercial information sources that allow sequence based searches within their proprietary sequence databases. Paid information sources like those hosted by STN™ and GenomeQuest™ are quite popular among sequence researchers and claim comprehensive coverage of all patented/published sequences.

Existing systems and methods provide a visual mapping between multiple biological sequences, such as a primer (forward and reverse) sequence, a probe sequence, a target nucleic acid sequence etc. The visual mapping may also include restriction enzymes, open reading frames (ORFs), conserved regions or start and stop segments, as well as locations of various genes of interest on the biological sequence. The existing systems and methods provide for a visual mapping that is represented in fragments. Such fragmented representation results in a cumbersome review or analysis process as a user has to scroll through multiple display windows to view the complete visual mapping.

At least in view of above, there is a need for a system and a method that provides for an improved visual representation of mapping between biological sequences.

### SUMMARY

Embodiments of a system for displaying a mapping between one or more nucleic acid sequences and a biological sequence are disclosed. The system includes a graphical user interface to receive a set of input parameters. The system further includes an illustration engine for mapping the nucleic acid sequences onto the biological sequence based on the received input parameters. The system further includes a display module for displaying the mapping through the graphical user interface. The mapping is displayed on a single display window of the graphical user interface.

Embodiments of a method for displaying a mapping between one or more nucleic acid sequences and a biological sequence are disclosed. The method includes receiving a set of input parameters. The method further includes mapping the nucleic acid sequences onto the biological sequence based on the received input parameters. The method further includes generating a visual map for depicting the mapping and displaying the visual map through a graphical user interface. The visual map is displayed on a single display window of the graphical user interface.

### BRIEF DESCRIPTION OF THE FIGURES

The following detailed description of the embodiments of the disclosed disclosure will be better understood when read with reference to the appended drawings. The present disclosure is illustrated by way of example, and is not limited by the accompanying figures, in which like references indicate similar elements.

FIG. 1 is a block diagram of a computing environment for displaying a mapping between one or more nucleic acid sequences and a biological sequence in accordance with an embodiment;

FIG. 2 is a block diagram of an computing device for displaying a mapping between one or more nucleic acid sequences and a biological sequence in accordance with an embodiment;

FIG. 3(a) illustrates a first exemplary user interface in accordance with an embodiment;

FIG. 3(b) illustrates a second exemplary user interface in accordance with an embodiment;

FIG. 3(c) illustrates a third exemplary user interface in accordance with an embodiment;

FIG. 3(d) illustrates an exemplary visual map in accordance with an embodiment;

FIG. 3(e) illustrates an exemplary click-to-expand view of the visual map in accordance with an embodiment;

FIG. 4 is a flowchart illustrating a method for displaying the mapping between the one or more nucleic acid sequences and the biological sequence in accordance with an embodiment; and

FIG. 5 is a flowchart illustrating a method for displaying the mapping between the one or more nucleic acid sequences and the biological sequence in accordance with another embodiment.

### DETAILED DESCRIPTION

Various terms that appear in the following description have been defined below:

Biological sequence: The term “biological sequence” or “biological DNA” refers not only to chromosomal DNA found within the nucleus, but also organelle DNA found within subcellular components (e.g., mitochondrial, plastid) of the cell. In some embodiments, biological DNA may include sequences from all or a portion of a single gene or from multiple genes. Further, the biological sequence can have a biological origin or can be synthetic.

Gene: The term “gene” refers to a segment of DNA that contains all the information for the regulated biosynthesis of an RNA product, including promoters, exons, introns, and other untranslated regions that control expression.

Nucleic acid sequence: The terms “nucleic acid” or “nucleic acid sequence” or “nucleotide sequence” are used interchangeably and refer to a polymeric form of nucleotides, either ribonucleotides or deoxynucleotides or a modified form of either type of nucleotide optionally containing synthetic, non-natural or altered nucleotide bases. The terms should also be understood to include, as equivalents, analogs of either RNA or DNA made from nucleotide analogs, and, as applicable to the embodiment being described, single-stranded (such as sense or antisense) and double-stranded polynucleotides, and artificial sequences. The nucleic acid sequence may be contained within a larger nucleic acid molecule, vector, or the like. Nucleotides (usually found in their 5′-monophosphate form) are referred to by their single letter designation as follows: “A” for adenylate or deoxyadenylate (for RNA or DNA, respectively), “C” for cytidylate or deoxycytidylate, “G” for guanylate or deoxyguanylate, “U” for uridylate, “T” for deoxythymidylate, “R” for purines (A or G), “Y” for pyrimidines (C or T), “K” for G or T, “H” for A or C or T, “I” for inosine, and “N” for any nucleotide. In addition, the orderly arrangement of nucleic acids in these sequences may be depicted in the form of a sequence listing, figure, table, electronic medium, or the like

Primer and Probe: The terms “primer” and “probe” are not limited to oligonucleotides or nucleic acids, but rather encompass molecules that are analogs of nucleotides, as well as nucleotides. Nucleotides and polynucleotides, as used herein shall be generic to polydeoxyribonucleotides (containing 2-deoxy-D-ribose), to polyribonucleotides (containing D-ribose), to any other type of polynucleotide which is an N- or C-glycoside of a purine or pyrimidine base, and to other polymers containing normucleotidic backbones, for example, polyamide (e.g., peptide nucleic acids (PNAs)), and other synthetic sequence-specific nucleic acid polymers providing that the polymers contain nucleobases in a configuration which allows for base pairing and base stacking, such as is found in DNA and RNA.

Target sequence: The terms “target nucleic acid” or “target sequence” as used herein refer to a sequence which includes a segment of nucleotides of interest to be amplified, sequenced and/or detected.

Contiguous nucleic acid sequence: The term “contiguous nucleic acid sequence” refers to the continuous orderly arrangement of bases without any break in a nucleic acid sequence.

Sequencing: The term “sequencing” refers to determining the primary structure (or primary sequence) of an unbranched biopolymer. Sequencing results in a symbolic linear depiction known as a sequence which succinctly summarizes much of the atomic-level structure of the sequenced molecule. As used herein “nucleic acid sequencing” is the use of sequencing for determining the order of the nucleotide bases—adenine, guanine, cytosine, and thymine—in a molecule of DNA.

Database: The term “Database” refers to a large collection of computerized (“digital”) nucleic acid sequences, protein sequences, or other sequences stored on a computer or server or hard disk. A database can include genome and/or gene sequences from only one organism (e.g., a database for all genes in Saccharomyces cerevisiae), or it can include genome and/or gene sequences from all organisms whose DNA has been sequenced.

Annotation: The phrase “Annotation” refers to “genome annotation” or “gene annotation” and necessarily involves the process of attaching biological information to sequences. It primarily consists of identifying elements on the genome i.e. gene prediction, and attaching biological information to these elements.

Alignment: The term “alignment” refers to the arrangement between the matching bases in the contiguous nucleic acid sequences of two biological sequences. The alignment can be identified by various alignment tools or algorithms well known in the art such as BLAST, ClustalW and the like.

The present disclosure can be best understood with reference to the detailed figures and description set forth herein. Various embodiments are discussed below with reference to the figures. However, those skilled in the art will readily appreciate that the detailed description given herein with respect to these figures is just for explanatory purposes as the method and the system extend beyond the described embodiments. For example, those skilled in the art will appreciate, in light of the teachings presented, recognizing multiple alternate and suitable approaches, depending on the needs of a particular application, to implement the functionality of any detail described herein, beyond the particular implementation choices in the following embodiments described and shown.

Also, it is to be understood that the phraseology and terminology used herein is for the purpose of description and should not be regarded as limiting.

The present disclosure relates to a system and a method for displaying a mapping between one or more nucleic acid sequences and a biological sequence. The system receives one or more input parameters from a user. Based on the input parameters, the system maps the nucleic acid sequences onto the biological sequence. The system then generates a visual map to depict the mapping between the nucleic acid sequences and the biological sequence. The visual map is then displayed to a user. The system also stores the input parameters and the visual map in a database for future use. The visual map can also include annotations of information that leads to meaningful inferences. In contrast to the existing systems and methods, the disclosed embodiments enable a user to view the visual map in a single display window without having to scroll through multiple display windows. Moreover, the user can simply click to expand the visual map or a portion thereof to focus on a particular segment of the biological sequence. In addition, new sequence information can be added in a time efficient manner without having to generate the visual map from scratch. These and many other advantages of the disclosed embodiments will become evident from the following description.

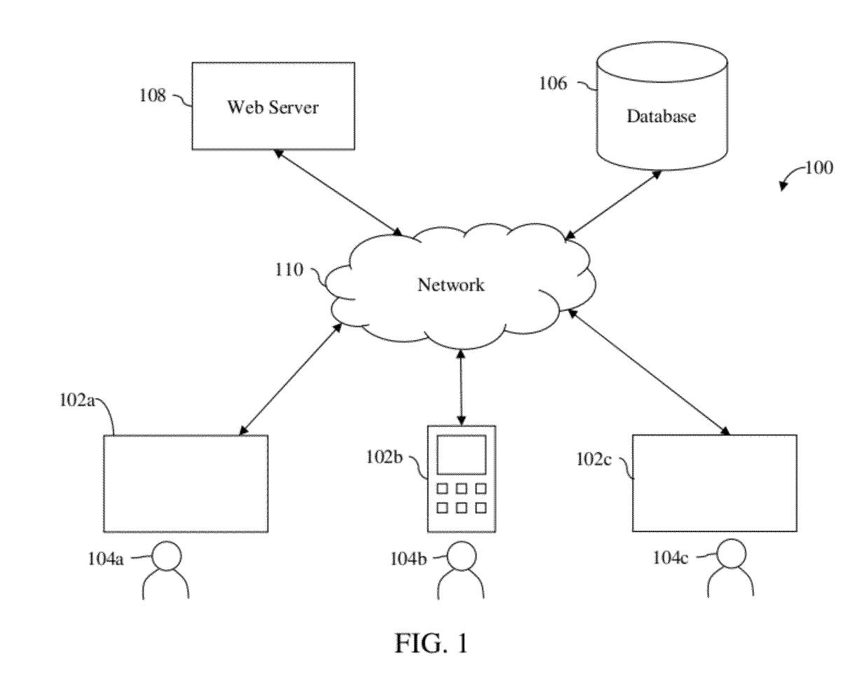

FIG. 1 is a block diagram of a computing environment 100 for displaying a mapping between one or more nucleic acid sequences and a biological sequence in accordance with an embodiment. The computing environment 100 includes computing devices 102a, 102b and 102c operated by users 104a, 104b and 104c respectively. For purposes of the ongoing description, embodiments of the present disclosure have been described for a computing device 102 being operated by a user 104. It may be appreciated that the disclosed embodiments are applicable to the computing devices 102a, 102b, and 102c. In an exemplary embodiment, the computing devices 102a, 102b, and 102c may correspond to a same genre of computing devices. For example, each of the computing devices 102a, 102b, and 102c may correspond to a computer system being used by the users 104a, 104b and 104c respectively. In an alternative embodiment, the computing devices 102a, 102b, and 102c may correspond to different genres of computing devices. For example, the computing device 102a may be a computer system, the computing device 102b may be a smart phone and the computing device 102c may be a laptop. The computing environment 100 further includes a database 106, a web server 108 and a network 110. The computing devices 102a, 102b and 102c, the database 106 and the web server 108 communicate with each other using the network 110.

The database 106 corresponds to a storage device. The database 106 may be a relational database or a non-relational database. The database 106 can be implemented by using several technologies that are well known to those skilled in the art. Some examples of technologies include, but are not limited to, MySQL®, Microsoft SQL®, etc. In an embodiment, the database 106 stores multiple biological sequences, annotation information of the biological sequences, and mapping between the biological sequences, etc. In another embodiment, the database 106 may correspond to a proprietary data storage owned by content publishers. In such an embodiment, the access may be granted on a subscription basis. In certain other embodiments, such databases can correspond to public databases that can be accessed free of cost.

The web server 108 hosts one or more web pages corresponding to a domain.

Further, in an embodiment, the web server 108 can be a single device. In another embodiment, the web server 108 can be a cluster of computing devices. In an embodiment, the web server 108 corresponds to a web analytic system with capabilities to extract and analyze data for commercial purposes. Further, the web server 108 may include various analytical tools configured for mapping biological sequences. Such tools may include Visual Basic tools, JAVA tools, amongst others. In an embodiment, the web server 108 can be a computing device having processing and storage capabilities for mapping biological sequences.

For example, the web server 108 can be configured to map one or more nucleic acid sequences to a biological sequence. In such an embodiment, the web server 108 may provide a web-based service to one or more subscribers (e.g. user 104a). The web-based service can offer users with various options to map various biological sequences. The user 104 can be prompted to provide input on a webpage hosted by the web server 108.

The computing device 102 includes a browser to access web pages hosted by the web server 108. The user 104 registers with the web server 108 for availing the web-based service. Upon successful registration, the web server 108 creates a profile account of the user 104 and provides a username and a password. This enables the user 104 to interact with the web server 108 via the network 110. In another embodiment, the user 104 can download software applications stored in the web server 108 upon successful authentication. Once downloaded, the user 104 can install the software application on the computing device 102. In an exemplary embodiment, the software application corresponds to a set of codes or instructions that when executed generates mapping between biological sequences.

In an embodiment, the sequence length of the one or more nucleic acid sequences is less than or equal to the sequence length of the biological sequence. The nucleic acid sequences can be patented sequences, non-patented sequences, publicly available sequences etc. In another embodiment, the one or more nucleic acid sequences may include patented primer sequences and patented probe sequences. The information on the one or more nucleic acid sequences can be obtained from sequence data published in patents/patent applications. In yet another embodiment, the one or more nucleic acid sequences may include antisense sequences, RNAi sequences, miRNA sequences and the like. In yet another embodiment, the one or more nucleic acid sequences may include target sequences. A target sequence comprises a segment of the genome sequence that is completely or partially amplified, sequenced and/or detected. In another embodiment, mapping may be done between amino acid sequences and polypeptide/protein sequences wherein the sequence length of the amino acid sequences are less than or equal to the sequence length of the polypeptide/protein sequences.

The network 110 is a medium through which content and messages flow between various entities of the computing environment 100. The network can be, for example, a Wireless Fidelity (Wi-Fi) network, a Wireless Area Network (WAN), a Local Area Network (LAN) or a Metropolitan Area Network (MAN). The network 102 can connect with various devices in the computing environment 100 through a variety of wired and wireless technologies such as Transmission Control Protocol Internet Protocol (TCP/IP), User Datagram Protocol (UDP), 2G, 3G or 4 G communication technologies.

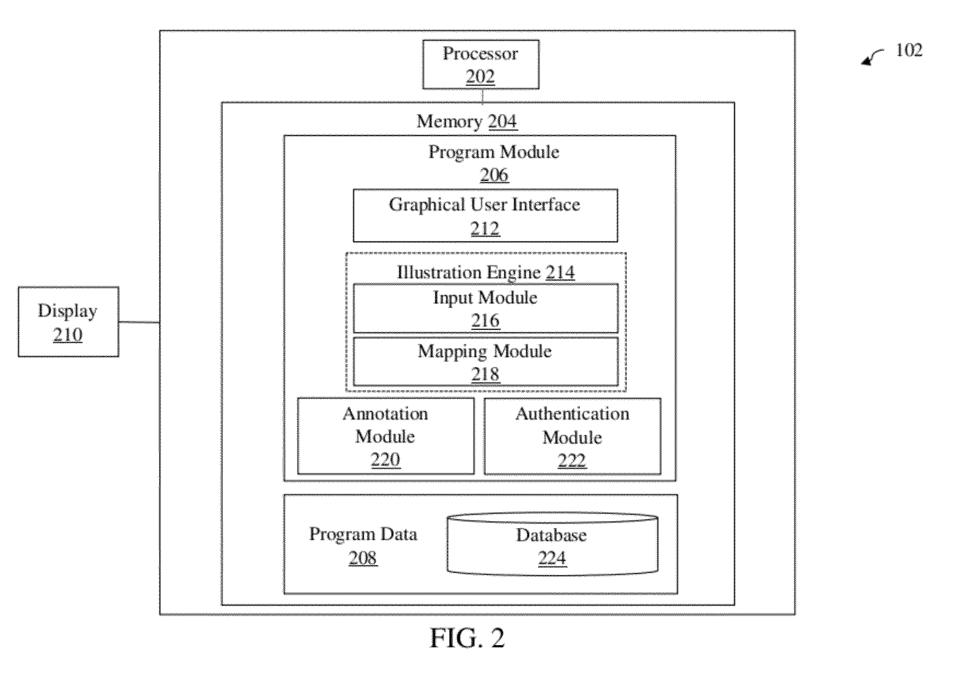

The functions performed by various modules present in the computing device 102 are explained in detail in conjunction with FIG. 2.

FIG. 2 is a block diagram of a computing device 102 for displaying a mapping between one or more nucleic acid sequences and a biological sequence in accordance with an embodiment. FIG. 2 will be explained in conjunction with FIG. 1. The computing device 102 includes a processor 202 coupled to a memory 204. The memory 204 includes one or more program modules 206 and program data 208. The processor 202 executes instructions stored in the program module 206 and stores one or more variables in the program data 208. The program module 206 includes a graphical user interface 212, an illustration engine 214, an annotation module 220 and an authentication module 222. The illustration engine 214 includes an input module 216 and a mapping module 218. The program data 208 includes the database 224.

The computing device 102 further includes a display 210 for displaying the mapping between the one or more nucleic acid sequences and the biological sequence. The display 210 corresponds to a display screen capable of presenting contents to the user 104. Examples of the display screen include, but are not limited to, a cathode ray tube display, liquid crystal display, electro luminescent display, plasma display, etc. A person ordinarily skilled in the art would appreciate and understand that the display 210 may be an integrated part of the computing device 102 or it may be a display screen connected to the computing device 102 using known technologies.

The graphical user interface (GUI) 212 presents a user interface (UI) on the display 210. Such a user interface enables the user 104 to provide a plurality of input parameters. The GUI 212 stores the received input parameters in the database 224. The input parameters may include information on contiguous nucleic acid sequence of the biological sequence and the one or more nucleic acid sequences to be mapped, and information on an alignment between the one or more nucleic acid sequences and the biological sequence. The sequence length of the one or more nucleotide sequences is less than or equal to the sequence length of the biological sequence. The GUI 212 can be configured to generate a visual representation of the mapping of the one or more nucleic acid sequences onto a biological sequence. The visual representation, thus generated, is displayed to the user 104 via the display 210.

The illustration engine 214 includes the input module 216 and the mapping module 218 to perform mapping of the one or more nucleic acid sequences onto the biological sequence based on the input parameters. The input module 216 retrieves and processes the input parameters from the database 224. In an embodiment, the input module 216 transforms the input parameters to variables that can be processed by the mapping module 218. The input module 216 stores such processed input parameters in the database 224.

Based on the input parameters (processed or otherwise) obtained from the database 224, the mapping module 218 generates a visual map displaying the alignment between each of the one or more nucleic acid sequences and the biological sequence. The mapping module 218 stores such mapping data and the visual representation of the mapping in the database 224.

The annotation module 220 annotates information to the one or more nucleic acid sequences and the biological sequence. The annotation module 220 then stores the annotated sequences in the database 224. In an embodiment, the information being annotated may include information on the source of the biological sequence, information on the sequence length of the biological sequence being mapped, information on the source of the one or more nucleic acid sequences, information on the sequence length of the one or more nucleic acid sequences, etc. It may be noted that, in certain embodiments, the biological sequences may be pre-annotated and may not require any annotation by annotation module 220. In some embodiments, it may be desirable to add information to pre-annotated biological sequences. The annotation module 220 can be configured to annotate such additional information.

In an embodiment, the annotation module 220 can be configured to access such information from the database 224. To this end, the database 224 can be populated with the information in advance. In an embodiment, the information can be obtained in runtime from various information sources. For example, the input module 216 can be configured to extract metadata from the input parameters and search for information based on the extracted metadata. The input module 216 can connect to well known offline or online resources to gather such information. For example, information related to the nucleic acid sequences and the biological sequence can be obtained from information sources such as National Center for Biotechnology Information (NCBI), European Bioinformatics Institute (EMBL), etc. The input module 216 can store such information in the database 224 for future use. In an embodiment, the input module 216 provides such information in runtime to the annotation module 220.

In an embodiment, GUI 212 can request for the type of information to be annotated to the biological sequences. The user 104 may be prompted to provide the annotation information through a UI displayed to the user 104. The user interface can provide options to specify the type of information to be annotated and also to provide the information itself. On receiving such information, the annotation module 220 annotates the information to the one or more nucleic acid sequences and the biological sequence.

The authentication module 222 authenticates access credentials of the user 104 when the user 104 accesses one or more software applications stored on the web server 108. The authentication module 222 receives the username and the password from the user 104. Thereafter, the authentication module 222 matches the username and password with the profile of the user 104 stored on the web server 108. If the username and the password match, the authentication module 222 grants access to the user 104. If the username and the password do not match, then the user 104 is denied the access to the web server 108.

The database 224 stores and maintains information related to the one or more nucleic acid sequences and the biological sequence, the annotated sequences and the visual map of the mapping between the one or more nucleic acid sequences and the biological sequence. In an embodiment, the database 224 can be configured to synchronize with the database 106 in a pre-defined manner. For example, the database 224 can be configured to synchronize with the database 106 on a daily, weekly, or monthly basis. In another embodiment, the database 224 may have restricted synchronization with the database 106.

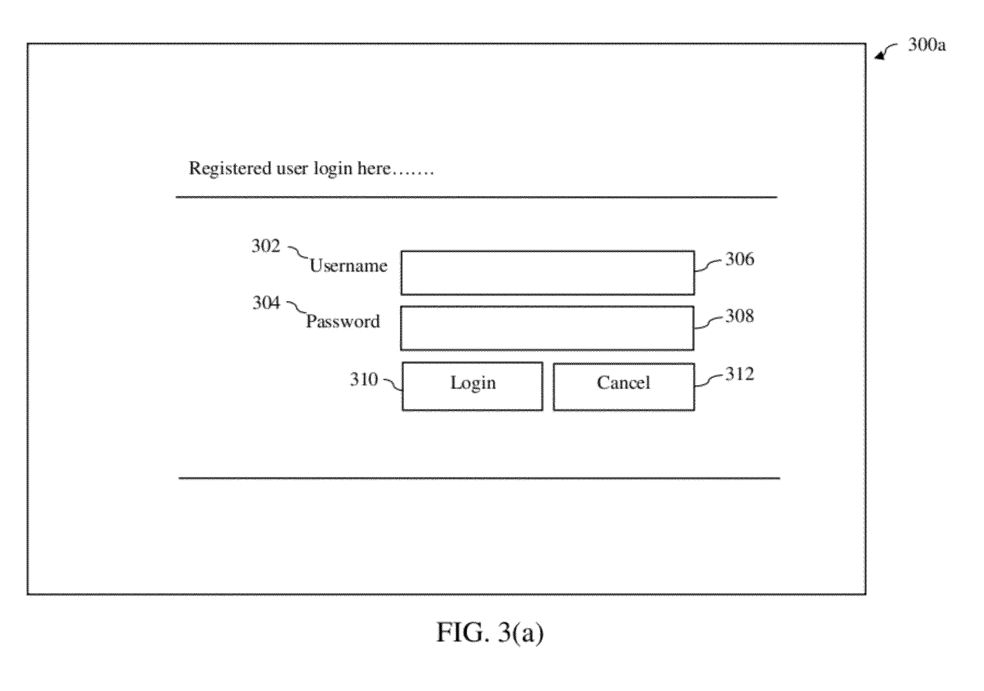

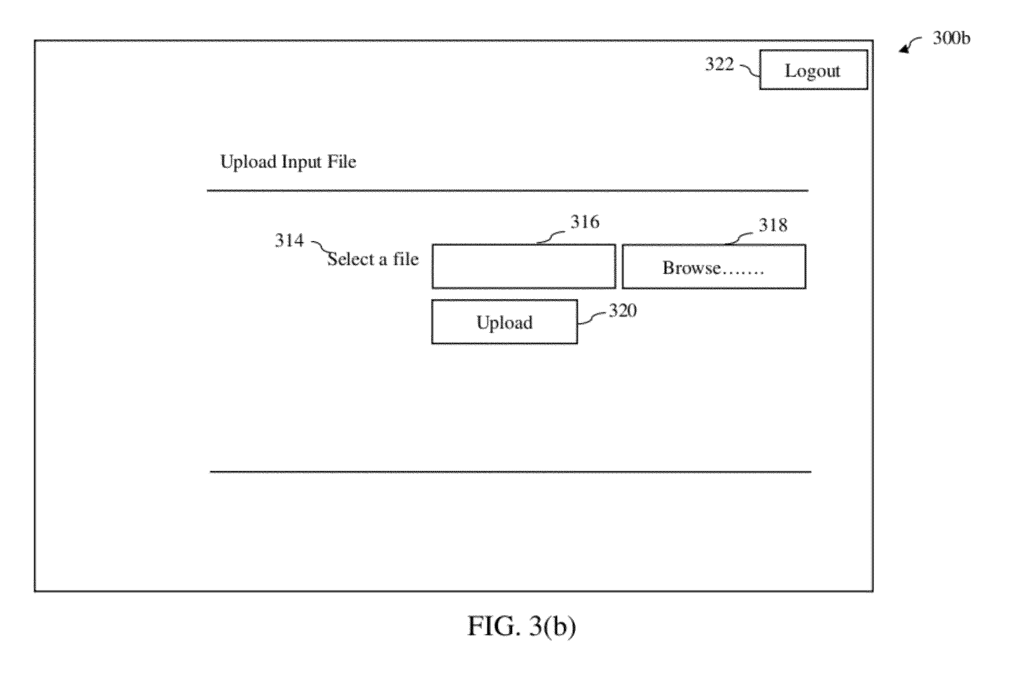

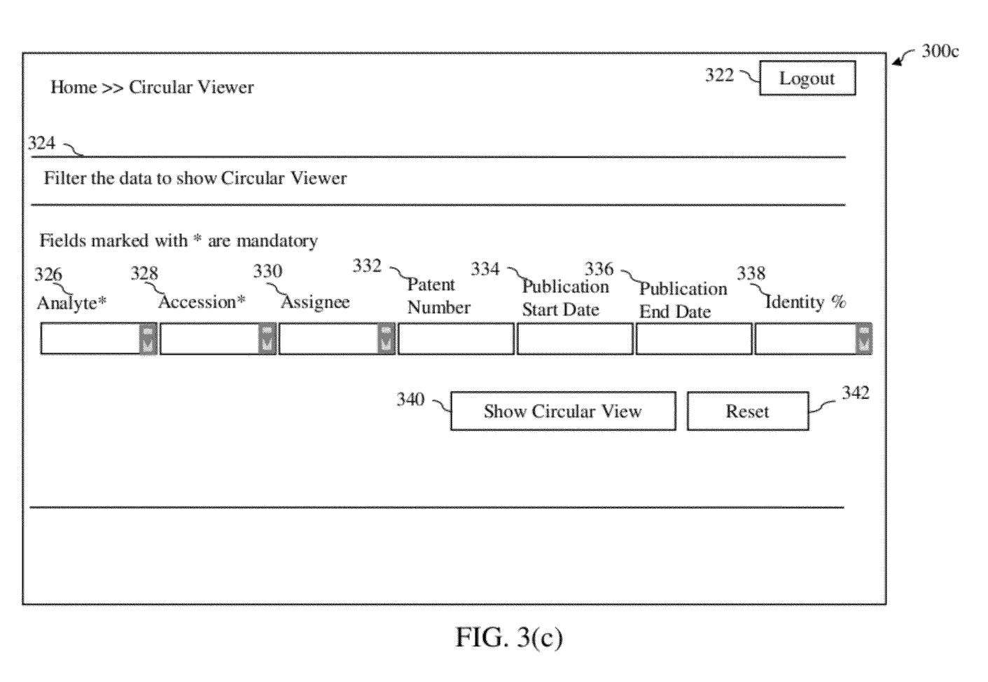

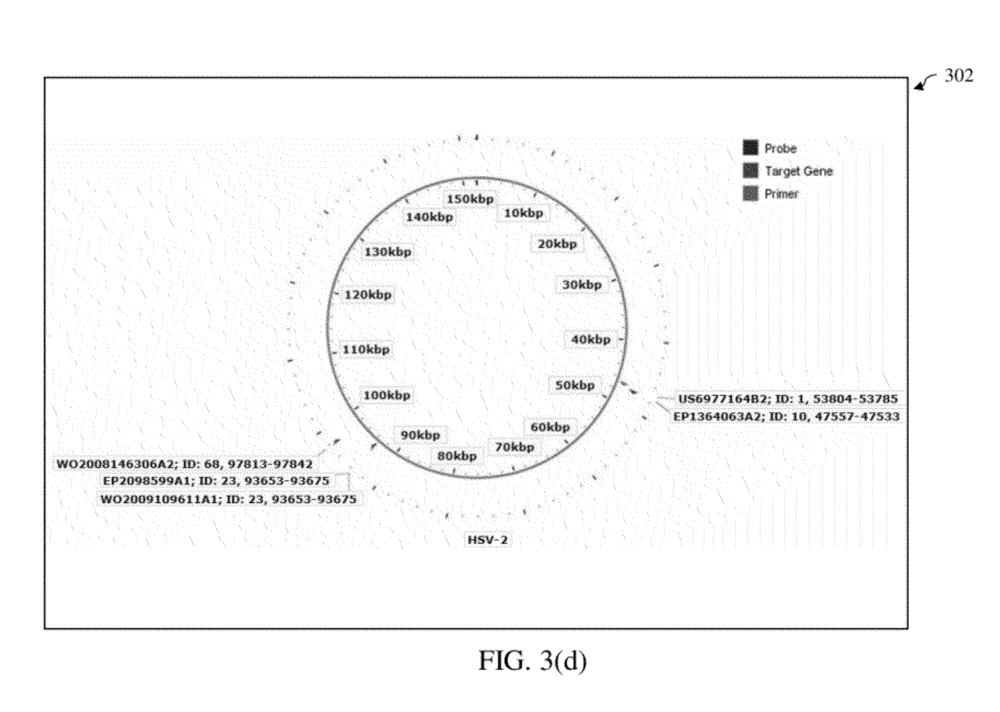

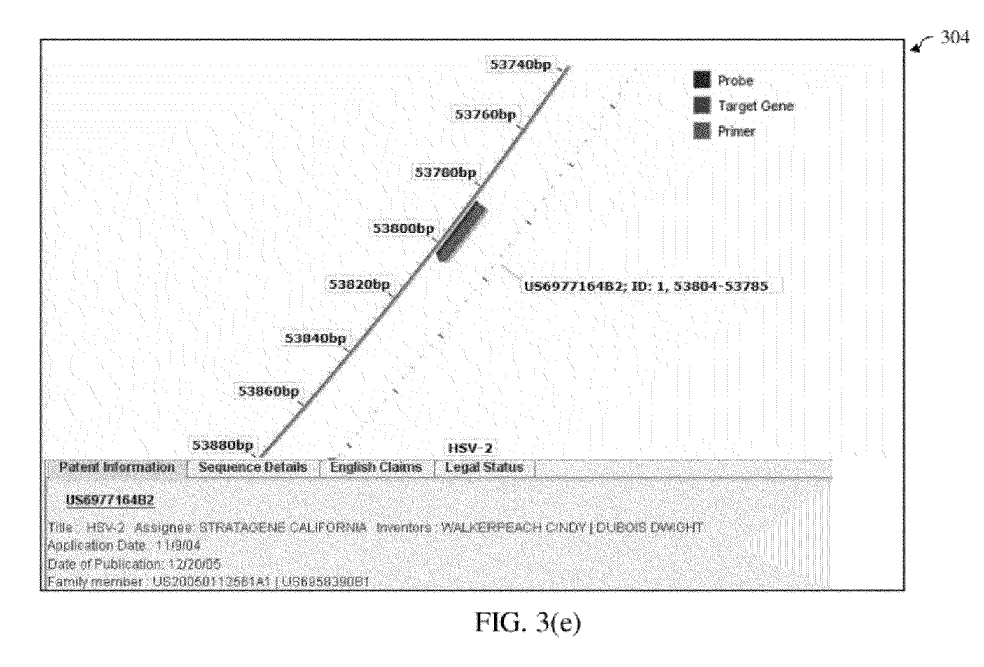

FIG. 3(a) illustrates a first exemplary user interface (UI) 300a in accordance with an embodiment. The UI 300a is displayed on the display 210 when the user 104 accesses either the software application stored in the web server 108 or the software application downloaded from the web server 108 (as explained in FIG. 2). The UI 300a prompts the user 104 to enter a username 302 and a password 304. The username 302 and the password 304 can be entered in text box 306 and text box 308 respectively. Once the user 104 has entered the username 302 and the password 304, the user 104 can either select a login tab 310 or a cancel tab 312. The login tab 310 takes the user 104 to a next window [as shown in FIG. 3(b)] and the cancel tab 312 stops the process.

FIG. 3(b) illustrates a second exemplary user interface (UI) 300b in accordance with an embodiment. The UI 300b is displayed to the user 104 when the user 104 selects the login tab 310 [as discussed in reference to FIG. 3(a)]. The UI 300b prompts the user 104 to select a file so that the user 104 can upload information for mapping the one or more nucleic acid sequences onto a biological sequence. It may be appreciated that the file can be in various formats known in the art. The user 104 uses a browse tab 318 to select the location of the file. Once selected, the path of the browsed file is shown in a box 316. Thereafter, the user 104 can select an upload tab 320 to upload the file. In case the user 104 does not want to continue further, the user 104 can exit the displayed page by selecting a logout tab 322. In an embodiment, the file can be stored locally in the database 224. In another embodiment, the file can be newly generated in runtime based on user inputs.

FIG. 3(c) illustrates a third exemplary user interface (UI) 300c in accordance with an embodiment. The UI 300c is displayed when the user 104 selects the upload tab 320 [as discussed in reference to FIG. 3(b)]. The UI 300c allows the user 104 to exercise an option of filter data 324 based on which the visual map can be generated. For example, the user 104 can filter the data by selecting an analyte 326, an accession 328, an assignee name 330, a patent number 332, a publication start date 334, a publication end date 336 and an identity percentage 338. In an embodiment, when the user 104 chooses to specify an analyte, a list of analytes can be provided in a drop down menu. Based on the selected analyte 326, a list of accession 328 related to the selected analyte 326 can be provided to the user 104. In an embodiment, the list of accession 328 is provided in a drop down menu. Further, the user 104 is also provided with a list of assignees 330 related to the selected analyte 326 and the selected accession 328. In an embodiment, the list of assignees 330 is provided in a drop down menu. The user 104 can also provide the patent number 332, the publication start date 334, the publication end date 336 and the identity percentage 338. Once the data has been provided by the user 104, the user 104 can select a show circular view tab 340 to get the visual map of the mapping. In case the user 104 wants to re-enter the data, the user 104 can select a reset tab 342. If the user 104 does not want to continue with the process, the user 104 can exit by using the logout tab 322. It may be noted that the fields specified by the user to filter data correspond to input parameters described with reference to FIG. 2.

FIG. 3(d) illustrates a visual map 302 displayed on the display of the computing device in accordance with an embodiment. The GUI 212 allows the user 104 to navigate through the visual map. In an embodiment, the user 104 can exercise various navigation options available, such as, but not limited to, zoom-in operation, zoom-out operation, point-to-view operation, click-to-expand operation, up-scroll operation and down-scroll operation. As illustrated in FIG. 3(d), the visual mapping is displayed in a single display window and the user (e.g. 104a) need not scroll between display windows to get a single complete view of the visual mapping of the biological sequences.

FIG. 3(e) illustrates an exemplary click-to-expand view 304 of the visual map displayed on the display of the computing device in accordance with an embodiment. As is evident from the figure, the user can focus on any desired segment or portion of the mapping to better represent the mapping.

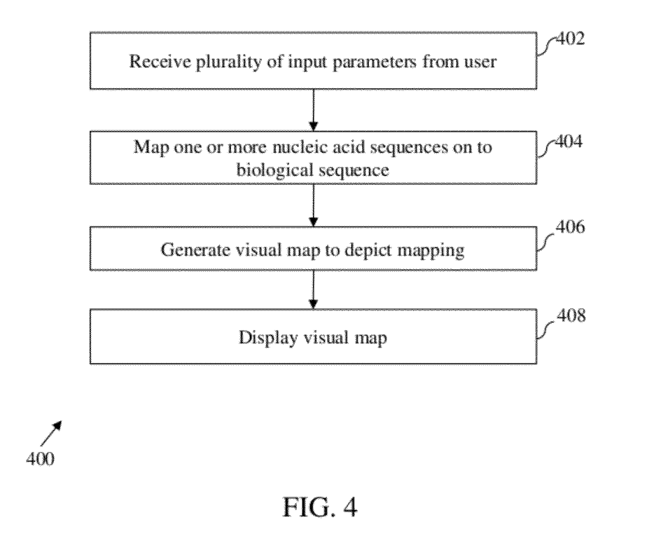

FIG. 4 is a flowchart illustrating a method for displaying the mapping between the one or more nucleic acid sequences and the biological sequence in accordance with an embodiment.

At step 402, input parameters are received. The UI 300c receives the input parameters from the user 104 and stores the input parameters in the database 224. The input module 216 of the illustration engine 214 retrieves and processes the input parameters from the database 224. The input module 216 transforms the input parameters to variables that can be processed by the mapping module 218. The input module 216 stores such processed input parameters in the database 224.

At step 404, mapping between the one or more nucleic acid sequences and the biological sequence is performed. The mapping module 218 of the illustration engine 214 obtains the input parameters from the database 224 and maps the one or more nucleic acid sequences onto the biological sequence based on the input parameters.

At step 406, a visual map of the mapping between the one or more nucleic acid sequences and the biological sequence is generated. The mapping module 218 generates the visual map to depict the mapping of the one or more nucleic acid sequences onto the biological sequence. In an embodiment, the annotation module 220 annotates information to the biological sequence prior to the generation of visual map. In an embodiment, the annotation module 220 annotates information subsequent to the generation of the visual map.

At step 408, the visual map is displayed to the user 104 on the display 210. The mapping is displayed in a predefined format. In an embodiment, the predefined format can be a geometrical format. Geometrical format used for visual representation of data can include linear format, rectangular format, triangular format, octagonal format, pentagonal format, spherical format, cubical format, etc. Other 2-dimensional and 3-dimensional graphical formats or a combination may be used for displaying the mapping between the one or more nucleic acid sequences and the biological sequence.

In an embodiment, the user 104 can navigate through the visual map. In an embodiment, the navigating options available to the user include a zoom-in operation, a zoom-out operation, a point-to-view operation, a click-to-expand operation, an up-scroll operation, and a down-scroll operation.

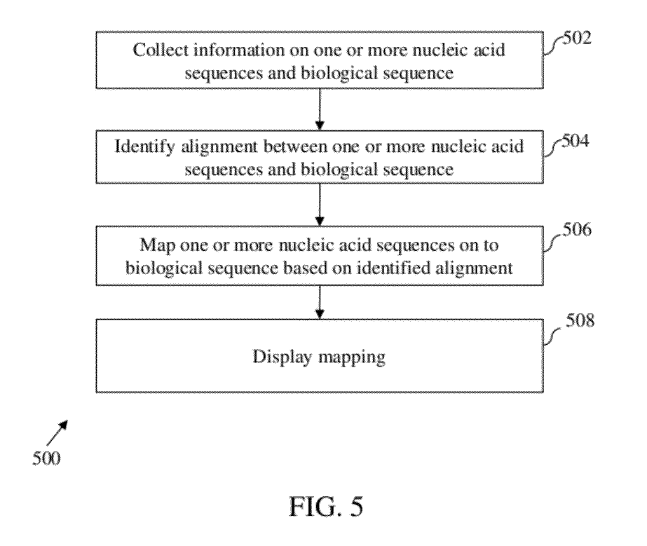

FIG. 5 is a flowchart illustrating a method for displaying the mapping between the one or more nucleic acid sequences and the biological sequence in accordance with another embodiment.

At 502, information on the one or more nucleic acid sequences and the biological sequence is collected. In an embodiment, the input module 216 collects the information based on the input parameters. The input module 216 can be configured to access such information from the database 224. For example, the database 224 can be populated with the information in advance. In an embodiment, the information can be obtained in runtime. In an embodiment, the input module 216 provides such information in runtime to the annotation module 220.

In an embodiment, GUI 212 can request for type of information to be annotated to the mapping. The user 104 may obtain the information from information sources and provide the information through GUI 212. The user interface can provide options to specify the type of information to be annotated and also to provide the information itself. On receiving such information, the annotation module 220 annotates the information to the one or more nucleic acid sequences and the biological sequence.

At step 504, the alignment between the one or more nucleic acid sequences and the biological sequence is identified. In an embodiment, the mapping module 218 determines the alignment between the one or more nucleic acid sequences and the biological sequence. The mapping module 218 stores such alignment information in the database 224.

In an embodiment, the mapping module 218 also determines a sequence length of the one or more nucleic acid sequences and a sequence length of the biological sequence. In an embodiment, the sequence length of the one or more nucleic acid sequences is less than or equal to the sequence length of the biological sequence. The mapping module 218 stores such sequence length information in the database 224.

At step 506, the one or more nucleic acid sequences are mapped onto the biological sequence based on the identified alignment.

At step 508, the mapping between the one or more nucleic acid sequences and the biological sequence is displayed to the user 104 on the display 210.

The disclosed embodiments of systems and methods have numerous advantages over the conventional methods and systems. For example, in the disclosed systems and methods, the visual map is displayed on a single window of the display 210. This enables the user 104 to view the entire mapping of the nucleic acid sequences on to the biological sequence in one go. Therefore, the visual representation of the mapping is more effective and user friendly.

In the foregoing specification, specific embodiments have been described. However, one of ordinary skill in the art appreciates that various modifications and changes can be made without departing from the scope of the disclosure. Accordingly, the specification and figures are to be regarded in an illustrative rather than a restrictive sense, and all such modifications are intended to be included within the scope of the present teachings

The system for visualizing the mapping of one or more nucleotide sequences on to a genome sequence, as described in the present disclosure or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present disclosure.

The computer system comprises a computer, an input device, and a display unit. The computer also comprises a microprocessor or processor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from many other databases. The communication unit includes a modem, an Ethernet card, or any similar device, which enables the computer system to connect to databases and networks such as LAN, MAN, WAN and the Internet. The computer system facilitates inputs from a user through an input device that is accessible to the system through an I/O interface.

The computer system executes a set of instructions that are stored in one or more storage elements in order to process the input data. The storage elements may also hold data or other information, as desired, and may be in the form of an information source or a physical memory element in the processing machine.

The programmable instructions may include various commands that instruct the processing machine to perform specific tasks such as the steps that constitute the method of the present disclosure. The method and systems described can also be implemented using only software programming or using only hardware or by a varying combination of the two techniques. The present disclosure is independent of the programming language used and the operating system in the computers. The instructions for the present disclosure can be written in all programming languages including, but not limited to ‘C’, ‘C++’, ‘Visual C++’ and ‘Visual Basic’. Further, the software may be in the form of a collection of separate programs, a program module with a larger program or a portion of a program module, as in the present disclosure. The software may also include modular programming in the form of object-oriented programming. The processing of input data by the processing machine may be in response to user commands, results of previous processing or a request made by another processing machine. The present disclosure can also be implemented in all operating systems and platforms including, but not limited to, ‘Unix’, ‘DOS’, ‘Android’, ‘Symbian’, and ‘Linux’.

The programmable instructions can be stored and transmitted on computer readable medium. The programmable instructions can also be transmitted by data signals across a carrier wave. The present disclosure can also be embodied in a computer program product comprising a computer readable medium, the product capable of implementing the above methods and systems, or the numerous possible variations thereof.

While various embodiments of the present disclosure have been illustrated and described, it will be clear that the present disclosure is not limited to these embodiments only. Numerous modifications, changes, variations, substitutions and equivalents will be apparent to those skilled in the art without departing from the spirit and scope of the present disclosure as described in the claims.

What is claimed is:

1. A system for displaying a mapping between one or more nucleic acid sequences and a biological sequence, the system comprising:
a graphical user interface configured for receiving a set of input parameters;
an illustration engine configured for mapping the one or more nucleic acid sequences onto the biological sequence based on the set of input parameters; and
a display module configured for displaying the mapping of the one or more nucleic acid sequences on to the biological sequence on a single display window of the graphical user interface.

2. The system according to claim 1, wherein the set of input parameters comprises one or more of information of contiguous nucleic acid sequence of the biological sequence, information of contiguous nucleic acid sequence of the one or more nucleic acid sequences, and information of an alignment between the contiguous nucleic acid sequence of the one or more nucleic acid sequences and the contiguous nucleic acid sequence of the biological sequence.

3. The system according to claim 1, wherein the illustration engine comprises a mapping module configured for:
mapping the one or more nucleic acid sequences onto the biological sequence based on the set of input parameters; and
generating a visual map for depicting the mapping of the one or more nucleic acid sequences on to the biological sequence.

4. The system according to claim 3 further comprising a database for storing the set of input parameters and the visual map.

5. The system according to claim 1 further comprising an annotation module configured for annotating the one or more nucleic acid sequences and the biological sequence.

6. The system according to claim 1, wherein the illustration engine further comprises an input module configured for:
extracting metadata from the input parameters and searching for information based on the extracted metadata, the information being associated with the one or more nucleic acid sequences and a biological sequence.

7. The system according to claim 1, wherein the one or more nucleic acid sequences include one of a primer sequence, a probe sequence, a target sequence, and an antisense sequence.

8. A method for displaying a mapping between one or more nucleic acid sequences and a biological sequence, the method comprising:
receiving a set of input parameters;
mapping the one or more nucleic acid sequences onto the biological sequence based on the set of input parameters;
generating a visual map for depicting the mapping of the one or more nucleic acid sequences onto the biological sequence; and
displaying the visual map on a single display window of a graphical user interface.

9. The method according to claim 8 further comprising navigating through the visual map.

10. The method according to claim 9, wherein the navigating comprises one or more of zoom-in operation, zoom-out operation, point-to-view operation, click-to-expand operation, up-scroll operation, and down-scroll operation.

11. The method according to claim 8 further comprising storing the set of input parameters and the visual map in a database.

12. The method according to claim 8, wherein the visual map is displayed in a geometrical format.

13. A computer program product for use with a computer, the computer program product comprising instructions stored in a computer usable medium having a computer readable program code embodied therein for displaying a mapping of one or more nucleic acid sequences onto a biological sequence, the computer readable program code comprising a set of instructions for:
collecting information associated with the biological sequence and the one or more nucleic acid sequences, the information including contiguous nucleic acid sequence of the biological sequence and contiguous nucleic acid sequence of the one or more nucleic acid sequences;
identifying an alignment between the contiguous nucleic acid sequence of the one or more nucleic acid sequences and the contiguous nucleic acid sequence of the biological sequence;
mapping the contiguous nucleic acid sequence of the one or more nucleic acid sequences on to the contiguous nucleic acid sequence of the biological sequence based on the identified alignment; and
displaying the mapping of the one or more nucleic acid sequences onto the biological sequence through a graphical user interface, wherein the mapping is displayed on a single window of the graphical user interface.

14. The computer program product according to claim 13 further comprising instructions for determining a sequence length of the one or more nucleic acid sequences and a sequence length of the biological sequence.

15. The computer program product according to claim 14, wherein the sequence length of the one or more nucleic acid sequences is less than or equal to the sequence length of the biological sequence.

16. The computer program product according to claim 13 further comprising instructions for annotating the one or more nucleic acid sequences and the biological sequence and storing the annotated sequences in a database.

17. The computer program product according to claim 16, wherein annotating the biological sequence comprises linking an information to one or more nucleic acid sequences and the biological sequence.

18. The computer program product according to claim 17, wherein the information comprises an information on a source of the biological sequence, information on the sequence length of the biological sequence, information on a source of the one or more nucleic acid sequences and information on the sequence length of the one or more nucleic acid sequences.
